(19) United States
(12) Patent Application Publication
(10) Pub. No.: US 2004/0242230 A1
(43) Pub. Date: Dec. 2, 2004

(54) Complex wireless service arrangement using wired or wireless communication systems

(76) Inventor: Seon-Soo Rue, Suwon-si (KR)

Correspondence Address: Robert E. Bushnell, Suite 300, 1522 K Street, N.W., Washington, DC, 20005-1202, US

(21) Appl. No.: 10/855,597

(22) Filed: May 28, 2004

(30) Foreign Application Priority Data
May 29, 2003 (KR) 2003-34535

(51) Int. Cl. H04Q 7/20

(52) U.S. Cl. 455/433; 455/426.2; 455/462; 455/554.2; 455/555

(57) ABSTRACT

A complex wireless service arrangement using wired or wireless communication systems allows, with a terminal device, a service using a broadband mobile communication system when the terminal device is positioned in a public wireless network (e.g., broadband wireless service network), and a service using a wired and wireless complex gateway where a home or private (narrowband wireless service) wireless technique such as WLAN, Bluetooth, UWB or the like is available, and a wired communication system such as xDSL/Ethernet/POTS or the like in an inbuilding/inhouse area. A call drop is prevented upon moving between areas when the terminal device is busy, and allows, in the narrowband service range, a service provided in the wired and wireless complex gateway, and a service in association with a broadband wireless network via the wired network.

### CLAIM OF PRIORITY

This application makes reference to, incorporates the same herein, and claims all benefits accruing under 35 U.S.C. §119 from an application for COMPLEX WIRELESS SERVICE DEVICE USING WIRED OR WIRELESS COMMUNICATION SYSTEMS earlier filed in the Korean Intellectual Property Office on May 29, 2003 and there duly assigned Serial No. 2003-34535.

### BACKGROUND OF THE INVENTION

1. Field of the Invention

The present invention relates to a complex wireless service arrangement using a wired or wireless communication system. More particularly, the present invention relates to a complex wireless service arrangement using a wired or wireless communication system adapted to perform voice and data services via a low-cost wired service network in a narrowband wireless service area associated with a wired service network using one terminal device. The terminal device has a plurality of service modes used in both a narrowband wireless system connected to a wired public network and a public broadband wireless system, and can be conveniently used in the narrowband service area.

2. Description of the Related Art

A typical wired telephone over a public telephone network is accepted as being the most familiar means of communication with the general public.

In addition to this wired telephone, a home communication device which is typically called a cordless phone and is adapted to move only within a user's residence began to be introduced in Korea in the late 1970s.

The cordless phone has a usable frequency band of 46/49 MHz, a typical interior coverage of about 50 m, and a channel interval of 25 KHz, and uses a frequency modulation (FM) system, in which a fixed channel system having a fixed usable frequency is initially used, but a multi channel access (MCA) system is commercially used, which would be a request channel system in the mid 1980.

In order to improve call quality, a 900 MHz band cordless phone was released in the 1990s.

Cordless phones that can be used only in a residence by realizing a cordless call transmission and reception on a typical home telephone as stated above are collectively called CT-1 (First Generation Cordless Phone) systems.

The CT-1 cannot be used in public places since it is intended for home use. In order to overcome such a limitation, outgoing call only CT-2 (Second Generation Cordless Phone) systems were introduced and include a terminal device that can be used in public places. The CT-2 outgoing call only portable phone was first proposed in England in 1989, and was adopted as the European standard in Europe. Presently, it has been used in some countries, and has been available as a commercial service in Korea in early 1997.

A CT-2 telephone is a wireless public telephone by which a walker can make a call while walking in a radius of 200 m. The CT-2 telephone can be used like a CT-1 telephone at home and as a public telephone in public places.

A drawback of the CT-2 telephone is that there is no incoming call function, handover function or the like. A system introduced to supplement this drawback is a CT-3 (Third Generation Cordless Phone) telephone system.

A CT-3 telephone might be classified into a private network dimension and a public network dimension according to its use. In the private network dimension, it can be described as a private branch exchange system (PBX).

The private branch exchange system is used extensively in a communication system for business purposes in an existing building, and a wireless private branch exchange system is used as a system allowing mobile communication in the building by making such a communication system wireless. There are a number of associated systems including a Digital European Cordless Telephone (DECT) system, for example.

The DECT system is a CT-3 telephone system that has been adopted as the European standard by the ETSI (European Telecommunications Standards Institute) in March of 1992.

The primary properties of the DECT system include a TDMA wireless connection system, a 2 GHz usable band, a 1.73 MHz channel bandwidth, and 12 time slots per channel.

A system evolved from the cordeless telephone, namely, a low tier PCS (Personal Communication Service) system has been introduced. This system has realized personal communications by allowing a call whenever, wherever and to anyone by developing the CT-3 telephone system into a public network demension through supplemented system functions such as handover, roaming or the like.

The low tier PCS is based on a cordless telephone, which is a system for providing a walker service and an indoor service. This system includes DECT in Europe, PHS (Personal Hand-phone System) in Japan, PACS (Personal Access Communication Service) in U.S., and the like.

There is a high tier PCS, corresponding to the low tier PCS, which adopts microcells to provide services based on vehicles including the walker through a developed analog cellular technique.

The analog cellular system, on which the high tier PCS is based, is a system originated by Bell Labs that developed AMPS (Advanced Mobile Phone Service) in October of 1983, with a cell concept as its feature being introduced, the channel band being 30 KHz in a band of 824˜894 MHz, and the modulation system being FM.

As the analog cellular system, NMT (Nordic Mobile Telephone), TACS (Total Access Cellular System) and the like were used in Europe, and an NTT system and the like were used in Japan.

However, as mobile phone subscribers rapidly increased in the late 1980s, limited capacity, degraded communication quality due to increased capacity, and a request for a variety of services in such systems resulted in a search for methods of improving this system.

In order to solve or reduce the capacity problem, communication quality and data service, which are drawbacks of the analog cellular system, a narrowband CDMA system was developed and commercially available in Korea since early 1996, and the IS-95 CDMA system was standardized in July of 1993 and the IS-54 TDMA system was also developed in the U.S.

Furthermore, a GSM (Group Special Mobile) system using TDMA was begun as a Pan-European system in Europe earlier than in other countries, and allows interconnection between respective European countries, and the commercial use thereof was begun in late 1992.

In Japan, PDC (Public Digital Communications) systems using TDMA were commercially available in early 1993.

While such digital cellular systems can solve call quality and capacity problems, it would be difficult to accept them as systems that can be used by the general public at a low cost. That is, they would be not suitable for providing normal services.

Thus, the high tier PCS (Personal Communication Service) evolved from a digital vehicle mobile phone system to provide the normal service. It has advantages of high-speed mobility, a simple network configuration, and utilization of digital cellular techniques.

The high tier PCS system includes an up-band IS-95 CDMA system evolved from IS-95 CDMA, a DSC-1800 system (digital communication system) evolved from GSM, or the like.

Although the development of the personal communication service (PCS) system can be described based on the independent high and low tier PCSs as described above, a recent high tier system has been developed to accommodate the low tier system, while the low tier system has been developed to accommodate the high tier system. As a result, a trend is to integrate two systems into the IMT-2000 (FPLMTS: Future Public Land Mobile Telecommunication System).

The IMT-2000 communication network has a structure in which the wired system and a wireless system are incorporated with inter-association, wherein the network is constructed from a low speed data transmission of 14.4 kbps in a wireless environment to a high speed data transmission of 384 kbps, and thus, many experts predict that activation of a wireless internet corresponding to a wired Internet in transfer rate will occur.

Recently, as a pre-step of the IMT-2000, several wired and wireless communication systems are being developed so that a wired and wireless incorporated service can be provided by incorporating a wired network, such as an already constructed public telephone network, and a wireless network, such as a mobile communication network.

Furthermore, even in an aspect of the mobile terminal, a mobile terminal has been developed supporting a plurality of bands and a plurality of modes (hereinafter, called a complex wireless terminal because it provides a plurality of band services and a plurality of mode services with a single mobile terminal). For example, there is a mobile terminal having a dual band/dual mode capable of simultaneously providing a cordless phone function and a moble communication function.

The dual band/dual mode mobile terminal, which simutaneously provides the wireless phone function and the mobile communication function, can support both a frequency band used in the wireless phone and a frequency band used in the mobile communication, which is thus referred to as a dual band, and it provides both the wireless phone mode and the mobile communication mode, which is thus referred to as a dual mode.

In addition, the dual mode mobile terminal includes a PCS/AMPS type mobile terminal and the dual band mobile terminal includes a GSM900/GSM 1800 type mobile terminal and the like.

The mobile terminal having both the plurality of bands and the plurality of modes can be operated in a single band/single mode by the manual operation of a user, and can be operated in a dual band/dual mode by the manual operation. Of couse, it is possible to maintain the connection with the communication network in which a better call quality can be assured by automatically moving from one communication network to another communication network.

Recently, a wireless communication network related technique has been significantly developed and many technique standards have been suggested. Remarkable technique standards include a Bluetooth technique standard and a wireless LAN standard. The Bluetooth technique and the wireless LAN are closely assocated with the mobile terminal, leading to a developed mobile terminal with a plurality of bands and a plurality of modes.

CDMA, GSM, GPRS or WCDMA used as a public wireless network technique, however, have high installation costs for control and base stations, and cover abroad region, which causes greatly degraded service quality in shaded regions.

In order to improve the service in the shaded region, additional equipment such as a repeater and the like are used, and thus, a general system requiring a relatively high network configuration cost compared to the wire network tends to impose a greater cost to the user. In addition, a data speed in a public wireless network is lower than that in private wireless and wired networks.

Moreover, a wireless communication system, which serves a narrow region such as WLAN, Bluetooth, UWB or the like, can provide a high quality service in view of data speed and quality with a low cost as compared to a public network, but has a drawback in that the service area is not broad and the mobility is constrained. Radio common carriers or private network installation companies largely install these systems. A wireless solution in the private network is provided through competition with the radio common carriers for a wireless voice/data service. However, there is a mobility constraint.

The following patents each discloses features in common with the present invention but do not teach or suggest the inventive features specifically recited in the present application: U.S. Patent Application No. 2002/0147009 to Kocheisen, entitled WIRELESS TELEPHONE SYSTEM WITH BOTH CORDLESS SHORT RANGE COMMUNICATION AND LONG RANGE MOBILE WIRELESS CELLULAR TELEPHONE COMMUNICATION, published on Oct. 10, 2002; U.S. Patent Application No. 2003/0092451 to Holloway et al., entitled METHOD OF MOBILE PHONE CONSOLIDATION, published on May 15, 2003; U.S. Pat. No. 6,678,533 to Karapetkov et al., entitled METHOD FOR CONNECTING AN INCOMING CALL IN A WIRELESS TELECOMMUNICATIONS INSTALLATION TO A DUAL MODE TERMINAL, issued on Jan. 13, 2004; U.S. Pat. No. 6,470,179 to Chow et al., entitled AUTOMATIC SERVICE SELECTION FEATURE FOR NEIGHBORHOOD RESIDENTIAL CORDLESS SER VICE, issued on Oct. 22, 2002; and U.S. Pat. No. 5,537,610 to Mauger et al., entitled MOBILE COMMUNICATION HAVING MOBILE SUBSCRIBERS, PCN NETWORK, PBX AND A LOCAL EXCHANGE, issued on Jul. 16, 1996.

### SUMMARY OF THE INVENTION

It is, therefore, an object to provide a complex wireless service arrangement using wired or wireless communication systems, which is capable of providing a service, by means of one terminal device, using a broadband wireless service mobile communication system when the terminal device is at a location away from a narrowband wireless service network, and using a wired and wireless complex gateway in which a narrowband wireless service technique such as WLAN, Bluetooth, UWB or the like and a wired communication system such as xDSL, Ethernet, POTS or the like are incorporated, in inbuilding/inhouse areas.

Furthermore, it is another object of the present invention to provide a complex wireless service arrangement using wired or wireless communication systems that is capable of preventing call drop upon moving between two regions while a terminal device is busy, and to provide, in a narrowband wireless service range, a service provided in a wired and wireless complex gateway, and a service in association with a broadband wireless network via a wired network.

According to one aspect of the present invention for achieving the above-noted objects, a complex wireless service arrangement using wired or wireless communication systems can comprise an access point (AP), the AP using a narrowband wireless protocol and being connected to a DSLAM (Digital Subscriber Line Access Multiplexer) in an inhouse area and to a private branch exchange in an inbuilding area via an internal wired and wireless complex gateway according to a wired network structure connected to a public network or a private network, the AP sending information to the complex wireless terminal arrangement or sending incoming paging information on a terminal, receiving a connection signal from the wireless complex terminal arrangement to allocate a network connection channel, and providing a gateway function via a PSTN (Public Switched Telephone Network) connection, a LAN connection function via an arbitrary wired communication line connection, and a handoff function between the APs placed in the private network; a gateway connected to the private network and the public network and adapted to interface data transmitted and received between networks; a home location register (HLR), the HLR being a database that is disposed in the gateway and the private network/public network and adapted to store public network or private network subscriber information, the HLR effecting perfect failure monitoring and real time database processing, and performing registration/cancellation of private network or public network subscriber information and complex wireless terminal arrangement information and renewal of all information in association with a switching center, a short message service center, a network management center, and a customer center; an authentication, authorization and accounting (AAA) server configured in the private network and the public network and adapted to manage usage authentication, authorization and accounting of private network and public network subscribers; and a wired management server configured in the broadband network and the wired network and adapted to provide various content information requested by the user when various content services are requested from the complex wireless terminal via the broadband network or the wired network.

Furthermore, according to another aspect of the present invention, a method of handling an outgoing call in a complex wireless terminal using a wired and wireless complex service system can comprise the steps of: performing a call service setting procedure at the access point using a narrowband air protocol and performing call resource confirmation and terminal authentication if a call setup request exists from the complex wireless terminal arrangement to an access point; providing a call setup response signal to the complex wireless terminal, and connecting the call to a PSTN office line if the authentication is completed; and generating a ringback tone signal at the wireless complex terminal to indicate that the call is being connected in response to the call setup response signal sent from the access point, and performing a call connection to a correspondent terminal in response to a busy signal generated after the call connection.

The method comprises the steps of: sending, at the central office exchange, call disconnection information of the wireless complex terminal to the wired AAA server if a called party requests a call disconnection while the complex wireless terminal and the correspondent terminal during a call; performing, at the access point, a call disconnection procedure using a narrowband air protocol if a call clearing request signal is received from the complex wireless terminal; and sending, at the access point, a call clearing response signal to the complex wireless terminal and at the same time, sending terminal disconnection information to the AAA server after performing the call disconnection procedure.

The method comprises the steps of: sending a call disconnection request signal from the complex wireless terminal, which has requested the call, to the access point if a call disconnection is requested from the complex wireless terminal, which has requested the call, during a call between the complex wireless terminal and the correspondent terminal; performing, at the access point receving the call disconnection request signal, a call disconnection procedure of a one-phone terminal via the narrowband air protocol and eliminating the call connected to the office line; and sending, at the access point, a call clearing response signal to the complex wireless terminal that has requested the call disconnection, and sending call disconnection information of the one-phone terminal to the AAA server if the call clearing has been completed.

In addition, if phone number information including area code information of a call correspondent wired terminal from the complex wireless terminal is sent to the access point via the private network, the access point separates the area code from the phone number transmitted from the terminal and thereafter transmits only the net phone number information of the wired terminal to the PSTN line.

Furthermore, a method according to an aspect of the present invention of call forwarding service for an outgoing call of a complex wireless terminal using a wired and wireless complex service system comprises the steps of: determining, at an access point, whether PSTN lines connected to the access point are all busy if a call signal is received from the complex wireless terminal positioned in a private network; providing, to the complex wireless terminal, current PSTN line status information and information indicating that a call forwarding to a broadband network is available and transmitting broadband network availability menu information to a one-phone terminal to display it on the complex wireless terminal if it is determined that all of the PSTN lines connected to the access point are busy; and connecting, at the access point, a call with a correspondent terminal via the broadband network by sending a phone number previously transmitted to the broadband network via the gateway by the user if a user selects a call forwarding menu to the broadband network in response to the displayed broadband network availability menu.

Furthermore, according to still another aspect of the present invention, a method of handling an outgoing call of a complex wireless terminal using a wired and wireless complex service system comprises the steps of: if a call signal is received from a complex wireless terminal positioned in a private network, determining, at an access point, whether PSTN lines connected to the access point are all busy; if it is determined that the PSTN lines are all busy, sending, at the access point, current busy status information of the PSTN line and data network (VoIP network) connection possibility information of the access point to the complex wireless terminal; and if data network connection is requested from the complex wireless terminal in resonse to the sent current busy status information of the PSTN line and data network connection possibility information, transmitting, at the access point, a phone number (i.e., digits) previously sent by a user to the data service network via a gateway to connet a call to a correspondent terminal via a VoIP network.

Moreover, a method according to an aspect of the present invention of handling an incoming call of a complex wireless terminal using a wired and wireless complex service system can comprise the steps of: specifying a CID of a specific complex wireless terminal for an incoming call reception into a database in an access point or a private branch exchange; if an incoming call is received from a PSTN/data network, analyzing whether or not the CID is included in the received incoming call at the access point or the private branch exchange; if the CID is included in the received incoming call, retrieving the CID of the incoming terminal specified into the database of the access point or the private branch exchange to determine whether or not the CID of the incoming specified terminal exists; if it is determined that the incoming specified terminal exists, determining whether or not an associated terminal is positioned in the terminal service area, and if the associated terminal is positioned in a terminal service area, requesting the incoming call service to the the incoming specified one-phone terminal; and if a call service response exists from the incoming specified associated terminal upon an incoming call service request, connecting a call between the terminals and performing the call service.

The method comprises the step of requesting an incoming call service for all terminals connected to the access point when no the incoming specified terminal exists in the database in the access point or the private branch exchange, when an associated incoming specified terminal is not positioned within the terminal service area, and when no call service response exists from the associated incoming specified terminal.

According to another aspect of the present invention, a method of handling an incoming call of a complex wireless terminal using a wired and wireless complex service system can comprises the steps of: if no call service response exists from an associated specific terminal when a call service is requested to the associated specific terminal while the call service is specified in a specific terminal for a received CID into a database in an access point or a private branch exchange, specifying an SMS service for sending an SMS message to the associated specific terminal; if an incoming call is received via a PSTN or a data network while the SMS service is specified to the specific terminal, determining, at the access point or the private branch exchange, whether or not the CID is included in the received incoming call; if it is determined that the CID is included in the associated incoming call, retrieving from the database whether an incoming specified terminal for the associated CID exists, and if the incoming specified terminal exists, requesting the incoming call to the associated terminal; if no response from the specified terminal exists in response to the incoming call request, calling all terminals connected to the AP; if no response to the call exists from all of the terminals after calling, sending an SMS message including the CID to the SMS specified terminal, and sending the SMS message including the CID to the correspondent terminal via the PSTN or the data network.

According to another aspect of the present invention, a method of handling an incoming call of a complex wireless terminal using a wired and wireless complex service system can comprise the steps of: specifying a call forwarding service to a specific terminal for a received CID into a database in an access point or a private branch exchange; if an incoming call is received via a PSTN or a data network while the call forwarding service is specified to the specific terminal, determining, at the access point or the private branch exchange, whether the CID is included in the received incoming call; if it is determined that the CID is included in the associated incoming call, retrieving from the database whether an incoming specified terminal for the associated CID exists, and if the incoming specified one-phone terminal exists, requesting the incoming call to the associated one-phone terminal; if no repsonse from a terminal specified in response to the incoming call request exists, calling all terminals connected to the access point, and if no response to the call from the all terminals exists, sending an SMS message including the CID to an SMS specified terminal, and then sending the SMS message including the CID to a correspondent terminal via the PSTN or the data network; and requesting, at the access point or the private branch exchange, a call forwarding service including specified specific terminal information to a public branch exchange.

According to another aspect of the the present invention, a method of handling an incoming call of a complex wireless terminal using a wired and wireless complex service system can comprise the steps of: if an incoming call service request exists from a PSTN or a wired data network, requesting, at an access point or a private branch exchange, an incoming call to the complex wireless terminal; if a response to the incoming call request from the terminal exists, performing a call connection of the incoming call to a one-phone terminal via the PSTN or the data network by sending an incoming call service response signal to the PSTN or the wired data network (public branch exchange); if an incoming call service request to the complex wireless terminal via the broadband network exists while a call between terminals is made via the PSTN/data network, notifying, at the terminal, incoming call information so that it is selected whether or not the incoming call from the broadband network is received by displaying a beep sound or a message for a broadband network incoming call service request to a user; and if a hold request for an previous call using an arbitrary key exists for the user to receive the incoming call from the broadband network, holding the previous call at the access point and notifying the hold for the previous call to the PSTN or the data network, and then sending a response signal to the sent incoming call to the broadband network to connect the call with a correspondent terminal via the broadband network.

Further, a content service method via a wired network in the wired and wireless complex service system can comprise the steps of: if a content service request exists from a complex wireless terminal, requesting, at an access point, a content service to an application server via the wired network in response to the content service request of the terminal; and sending, at the application server, a response signal to the content service request to the terminal via the access point in response to the content service request from the access point, and then downloading various content information, requested by a user, stored in the application server to the wireless complex terminal via the access point.

Further, according to the present invention, a home networking service method using a complex wireless terminal in a wired and wireless complex service system, can comprise the steps of: if a home networking service is requested from the terminal via a broadband wireless network to use the home networking service using an application server positioned in a wired network via the broadband wireless network, requesting a content service to the application server of the wired network via the broadband wireless network in response to the request from the terminal; sending, at the application server, a response signal to the content service request via the broadband wireless network to the terminal via the broadband wireless network; selecting a desired home network service to send it to the application server via the broadband wireless network according to a home networking service response of the application server; requesting, at the application server, a home electronic device control to the access point in response to the home electronic device control service request sent from the terminal; controlling, at the access point, an associated function of an associated home electronic device in response to a request of the home electronic device control from the application server, and when the control is completed, sending a home electronic device control response signal to the application server, and sending, at the application server that has received the home electronic device response signal, a response signal to a home networking service completion, to the terminal via the broadband network.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates a network connection configuration for a complex wireless service arrangement using wired or wireless communication systems according to an exemplary embodiment of the present invention;

FIG. 2 schematically illustrates an internal block configuration for a complex wireless terminal of FIG. 1;

FIG. 3 illustrates a task configuration for the complex wireless terminal of FIG. 2;

FIG. 4 illustrates a process of call handling when an outgoing call is generated by a complex wireless terminal;

FIG. 5 illustrates a process of handling a wire phone number in an AP when the phone number is transmitted to the AP via a complex wireless terminal;

FIG. 6 illustrates a call forwarding procedure to a broadband wireless service network upon a call originating from the complex wireless terminal to the AP;

FIG. 7 illustrates a call forwarding process to a VoIP network upon a call originating from the complex wireless terminal to the AP;

FIG. 8 illustrates a process of handling an incoming call when an incoming call is received from a PSTN network/data network to the AP;

FIG. 9 illustrates a process for hanlding a call to a specific terminal when an incoming call is received from a PSTN network/data network to the AP;

FIG. 10 is an operation flowchart specifically illustrating a handling process as shown in FIG. 9;

FIG. 11 illustrates a process for delivering an SMS message for an incoming call to a complex wireless terminal in case where the incoming call is received for a PSTN network/data network to the AP;

FIG. 12 illustrates a call forwarding service process for an incoming call to a complex wireless terminal when the incoming call is received from a PSTN network/data network to the AP;

FIG. 13 illustrates a process of handling an incoming call when the incoming call is received from a broadband wireless service network while a complex wireless terminal 11 arrangement is busy;

FIG. 14 illustrates a time period for explaining an active scanning operation of a complex wireless terminal arrangement to the AP;

FIGS. 15a and 15b illustrate scanning periods of a complex wireless terminal when the complex wireless terminal moves from a narrowband wireless service network and when the complex wireless terminal moves to the narrowband wireless service network, respectively;

FIG. 16 illustrates a scanning period of the terminal at a boundary between narrowband and broadband wireless service areas;

FIG. 17 illustrates a narrowband wireless service network registration precedure for receiving a data service in a complex wireless terminal arrangement;

FIG. 18 illustrates a process of using a public wired data network that supports a narrowband wireless service using a complex wireless terminal arrangement; and

FIG. 19 illustrates a process of receiving a content service via a wired data network in a complex wireless terminal.

### DETAILED DESCRIPTION OF THE INVENTION

Hereinafter, a complex wireless service arrangement using a wired and wireless communication system and a method thereof according to preferred embodiments of the present invention will be described in detail with reference to the accompanying drawings.

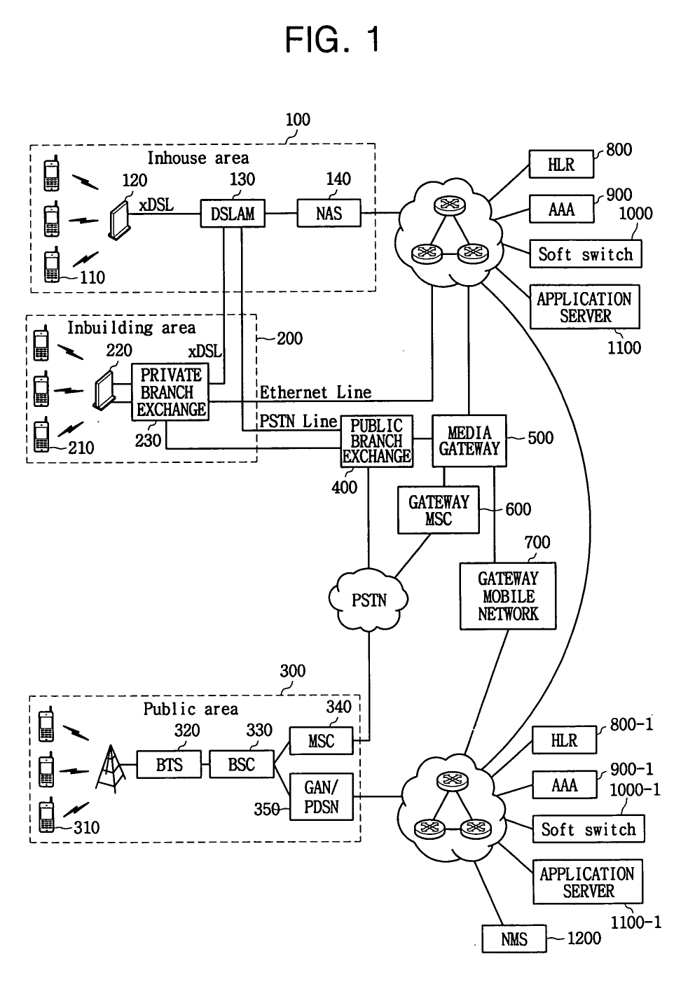

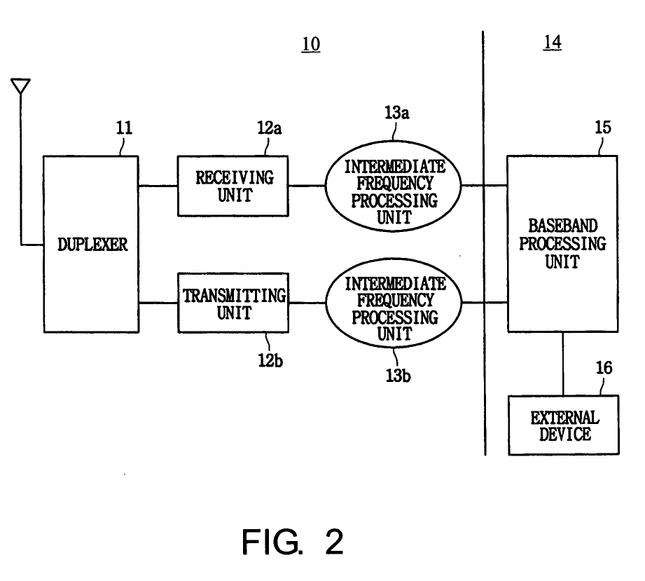

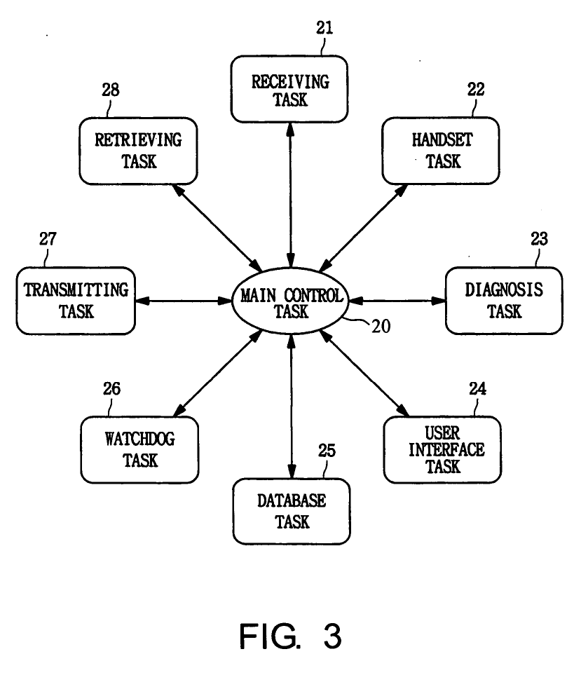

FIG. 1 illustrates a network connection configuration for a complex wireless service arrangement using wired or wireless communication systems according to an exemplary embodiment of the present invention, FIG. 2 schematically illustrates an internal block configuration for the complex wireless terminal of FIG. 1, and FIG. 3 illustrates a task configuration for the complex wireless terminal of FIG. 2.

As shown in FIG. 1, the complex wireless service arrangement can be configured of complex wireless terminal arrangements 110, 210 and 310, access points (APs) 120 and 220, a private branch exchange 230, a digital subscriber line access multiplexer (DSLAM) 130, a public branch exchange 400, a base station transceiver system (BTS) 320, a base station controller (BSC) 330, a mobile switching center (MSC) 340, home location registers (HLRs) 800 and 800-1, authentication authorization and accounting (AAA) servers 900 and 900-1, a packet data service node (PDSN) 350, a network management system (NMS) 1200, soft switchs 1000 and 1000-1, application servers 1100 and 1100-1, a media gateway 500, and a gateway MSC 600.

The complex wireless terminal arrangements 110, 210 and 310 each can be configured of a high frequency unit 10 and a baseband unit 14, as shown in FIG. 2. Here, the high frequency unit 10 can include a duplexer 11, a receiving unit 12a, a transmitting unit 12b, a receiving side intermediate frequency processing unit 12a, and a transmitting side intermediate frequency processing unit 13b. The baseband unit 14 can include a baseband processing unit 15, and an external device 16 such as a memory.

As shown in FIG. 3, a task construction of the complex wireless terminal devices 110, 210 and 310 comprises a main control task 20 for performing all task management and call processing including a process task generation, a process task control and a process task cancellation, a receiving task 21 for processing a reception related message, including analyzing a received message, a handset task 22 for managing movement of the complex wireless terminal such as a keyboard input, a diagnosis task 23 for performing control and data loading of the complex wireless terminal with an external communication, a user interface task 24 for displaying a usage state of the complex wireless terminal to a user, a database task 25, a watchdog task 26 for monitoring software, a transmitting task 27, and a retrieving task 28 for acquiring a pilot signal and a system such as timing changing or the like.

The complex wireless terminal devices 110, 210 and 310 configured as above are terminals that support a plurality of bands and a plurality of modes, which are basically capable of handling wireless LAN and Bluetooth as well as CDMA, GSM and WCDMA.

Adding a filter to the receiving unit 12a of the complex wireless terminal devices 110, 210 and 310 enables it to receive the plurality of bands, in which the plurality of modes are implemented through the baseband processing unit 15.

The retrieving task 28 of the complex wireless terminal acquires all signals in the plurality of bands and the plurality of modes from an associated system in an idle state to collect information and confirms whether a service is available from the system. Also, even though one system is providing the service, intensities of pilot signals of other systems are monitored periodically.

Upon the terminal moving from a mobile communication service region to a local wireless network service region, when a pilot signal of any access point in the local wireless network service region is sensed, the retrieveing task 28 sends an access point pilot signal sense message to the mobile exchange station so that a home position register manages it.

Each of the above-stated complex wireless terminal devices 110, 210 and 310 is a terminal that supports a dual mode, for example, a public mode and a private mode, and a software in the terminal basically can handle private networks, for example, wireless protocols (WLAN, Bluetooth, UWB and the like) that can be used in an inbuilding area 200 or an inhouse area 100 as well as wireless protocols used in a shared network, for example, CDMA, GSM, GPRS and WCDMA, which can be implemented with a single piece of software.

Further, a hardware structure of the complex wireless terminal devices 110, 210 and 310 should support different bands to which most modems or filter units belong. A sharable baseband processing unt is responsible for handling the different protocols.

The complex wireless terminal devices 110, 210 and 310 sense all types of signals available for services, obtain an associated system, for example, CDMA, GSM, GPRS, WCDMA, WLAN or Bluetooth, and collect information to confirm whether or not the system can provide services.

Moreover, a setting right is given to the user so that the user sets a priority for a system by which the user wants to receive the service, which means that a service network selection right is given to the user.

The APs 120 and 220 use a narrowband wireless protocol, such as WLAN and Bluetooth. The APs 120 and 220 are connected to the DSLAM 130 in the inhouse area 100 and to a private branch exchange 230 in the inbuilding area 200 via a wired and wireless complex gateway in the APs 120 and 220 according to the wired network structure connected from the public network or the private network, respectively.

The APs 120 and 220 basically send either AP information or paging information for terminal incoming to the complex wireless terminal devices 110, 210 and 310, and receive a connection signal from the complex wireless terminal devices 110, 210 and 310 to allocate a network connection channel.

Also, the APs 120 and 220 can perform a gateway function through PSTN connection and a LAN connection function through xDSL or Ethernet connection.

The APs 120 and 220 also provide seamless calls by providing a hand-off function between the APs, which are disposed in the inhouse area 100 and the inbuilidng area 200, namely, in the private network.

As shown in FIG. 1, the private branch exchange 230 placed in the inbuilding area 200 is an exchange system of a keyphone, PABX or the like used in the inbuilding area 200. The system is typically used in a structure where a number of extension users are adapted to effectively use a limited office line.

An extension line of the private branch exchange 230 typically is composed of an analog line and a digital line, and recently provides a solution that uses WLAN, Bluetooth, or the like in a wireless solution such as PWT, WDCT, DECT, or the like.

Further, an analog line, a digital line or the like is used as the office line, and in particualr, there are a variety of digital lines. For example, the digital lines include BRI (Basic Rate Interface), PRI (Primary Rate Interface), xDSL, 10/100 LAN, and the like.

The DSLAM 130 in the inhouse area 100 is DSL subscriber collecting equipment, in which a splitter is placed at the subscriber's home or private network. The DSLAM 130 provides data received over the DSL for the private branch exchange 230 in the NAS 140 or the inbuilding area 200.

The public branch exchange 400 connected to the private branch exchange 230 via the PSTN line corresponds to a typical central office exchange.

Meanwhile, the BTS 320 in the public network 300 performs a function of providing a mobile subscriber with mobile communication services through wireless-matching with the complex wireless terminal device 310, and provides the BSC 330 with voice and data, which are transmitted from the complex wireless terminal device 310.

The BTS 320 configures a wireless communication path with the complex wireless terminal device 310 belonging to a communication service area, namely, a cell area and performs fuctions of managing wireless resources.

The BSC 330 connects a voice call and a packet data call between the BTS 320 and the MSC 340, and the packet data call between the BTS 320 and the DCN (Data Core Network). The BSC 330 also performs a vocoding function on the voice call and a function of operating and maintaining BTS 320 under the control of BSM (Base Station Management).

The MSC 340 is a system for performing an exchange function in the wireless communication network, and serves to provide supplementary services by connecting the mobile subscriber with various additional equipments (SMS, VMS, or the like) in the network, or to provide services by connecting it with other networks.

Further, the MSC 340 transmits and receives PCM data to and from the BSC 330, and performs a wired exchange function through a connection to the central office wired exchange.

Each of the HLRs 800 and 800-1 is a database connected to the wired network and the wireless network (i.e., public network) for storing information on the mobile communication subscriber and the private network subscriber. It has a structure capable of perfect failure monitoring and real time database processing, and performs its function in association with a swiching center, a short message service center, a network management center, and a customer center.

Registration/cancellation of the subscriber information on the public and private network subscribers and renewal of all information are also made in the HRLs 800 and 800-1. Position information, roaming information and the like of a current terminal are registered as representative subscriber information. Local network service support information, local network position information, local network usage status information, a central office phone number, a unique wireless terminal number, and the like for ‘one-phone service’ are organized into a database.

Each of AAAs 900 and 900-1 is a server for managing user authentication, authorization and accounting, and is configured in the same form as that of RADIUS (Remote Authentication Dial In User Server).

The PDSN 350 is a packet exchange device such as SGSN (Server GPRS support node) or the like. It is a system for processing PPP (Point-to-Point) protocol and is an access point through which a mobile user connects to the Internet.

Moreover, the PDSN 350 performs the user authentication by connecting to the AAA server 900-1, and generates accounting information for each user to deliver to the AAA server 900-1. It also performs a foreign agent function of a mobile IP.

The NMS 1200 is an SNMP (Simple Network Management Protocol) manager, and is a system for managing the PDSN 350 and a home agent (PDGN).

Application servers 1100 and 1100-1 store a variety of Internet content information and, when a content request exists from the wireless complex terminal via the wired network or the wireless network, provides associated content information to the terminal.

The media gateway 500, the gateway MSC 600 and a gateway mobile network 700 are adapted to perform voice and data exchange between the wired network, a wireless voice network, and a wireless data network. They are used for a roaming service between different networks in the case of using a gateway, or for call forwarding to another network with respect to a call received by a user.

A complex wireless service method using a complex wireless service device that utilizes the thus configured wired and wireless communication system will be specifically described with reference to the accompanying drawings.

A concept of services for the complex wireless terminal devices 110, 210 and 310 applied to the present invention, namely, one-phone is first described. A chip for connection to an external network of CDMA, GSM or GPRS, and a chip for WLAN, Bluetooth or the like are mounted in the terminal devices 110, 210 and 310, and the WLAN or/and Bluetooth APs 120 and 220 are placed in the inhouse area 100 or the inbuilding area 200.

Accordingly, it is possible to perform a voice call by connecting to the PSTN network via the APs 120 and 220 using the wireless complex terminal devices 110, 210 and 310 that support the dual mode or the dual band. Also, where separate wired data lines (for example, ×DSL, ISDN, or the like) are connected to the APs 120 and 220, it is possible to utilize contents through connection to a wireless/wired Internet network via such data lines. Needless to say, in the external network (CDMA, GSM, GPRS or the like), it is possible to utilize an original call or a data service through the chips for connection to the external network.

In addition, it is possible to utilize a call service using VoIP in a certain case when the wired data line exists.

Meanwhile, an operation of handling an outgoing call from the wireless complex terminal device 200 will be described.

First, when a call is originated from the complex wireless terminal devices 110, 210 and 310 (hereinafter, referred to as a one-phone) registered on the complex APs 120 and 220 in the inhouse or inbuilding (for office) area, a connection is established to the PSTN network via the APs 120 and 220, which support a connection to a narrowband wireless network (WLAN, Bluetooth, or UWB) rather than a broadband wireless network service.

A PIN code between the one-phones 110 and 210 and the APs 120 and 220 as used herein is set so that only a specified terminal is connected to the APs 120 and 220.

Moreover, since the APs 120 and 220 have the wired data lines, an external network connection number or a terminal identification number (e.g., a phone number, an MAC address, an ESN number, or the like) of the one-phones 110 and 210 is transmitted to a wired management server system (e.g., AAA server) or a PSTN exchange via the data lines so that it is utilized as accounting and authentication data for each external network subscriber.

Further, the APs 120 and 220 recognize digits received from the one-phones 110 and 210 and analyze whether it is an extension call inside the APs 120 and 220 or an office line call so that it is processed.

If the call is not allowed due to a busy status of the PSTN lines when the one-phones 110 and 210 attempt call outgoing, a VoIP call is served via the data lines connected to the APs 120 and 220. Needless to say, when the data lines are not connected to the APs 120 and 220, a call service can be provided via the external network (CDMA, GSM, GPRS, WCDMA, or the like).

Hereinafter, the above-stated functions will be described in detail with reference to the accompanying drawings.

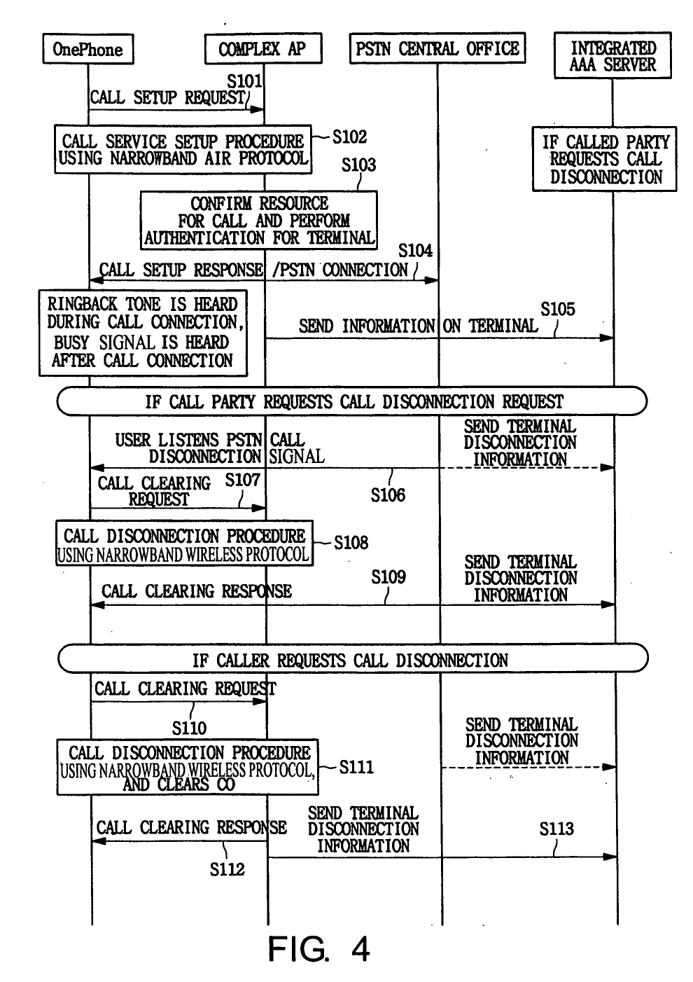

FIG. 4 illustrates a call-handling process when an outgoing call is generated from a complex wireless terminal device.

First, a call setup is requested from the one-phone to the AP (S101), the AP performs a call service setup precedure using a narrowband air protocol (S 102), and performs call resource confirmation and one-phone (i.e., terminal) authentication (S103).

When completing the one-phone authentication, the AP provides the one-phone with a call setup response signal, and connects a call to the PSTN central office line (S104). At this time, the AP then will send information on the one-phone terminal to an AAA server (S105).

Accordingly, in the one-phone terminal, a ringback tone signal is generated to indicate that a call is being connected in response to the call setup response signal transmitted from the AP, and then a busy signal is generated after a call connection. It means that the call connection to a correspondent terminal has been completed.

If a call party requests a call disconnection while the call has been established to the correspondent terminal through the one-phone terminal, a central office exchange transmits disconnection information of the one-phone terminal to the AAA server. At this time, the one-phone terminal will generate a call disconnection signal (S106).

When a call clearing request signal from the one-phone terminal is received while the call disconnection signal has been generated (S107), the AP performs a call disconnection procedure using the narrowband air protocol (SI 08).

After performing the call disconnection precedure, the AP sends a call clearing response signal to the one-phone terminal, and at the same time, sends terminal disconnection information to the AAA server (S109).

Meanwhile, when the one-phone terminal, which has requested the call, requests the call disconnection while the call is connected to the correspondent terminal, it first transmits a call disconnection request signal to the AP (S110).

The AP, which has received a call disconnection request signal, performs the call disconnection procedure of the one-phone terminal via the narrowband air protocol, and eliminates the call connected to the office line (S111).

When the call clearing is completed, the AP will send a call clearing response signal to the one-phone terminal, which has requested the call disconnection (S112) and send the call disconnection information on the one-phone terminal to the AAA server (S113).

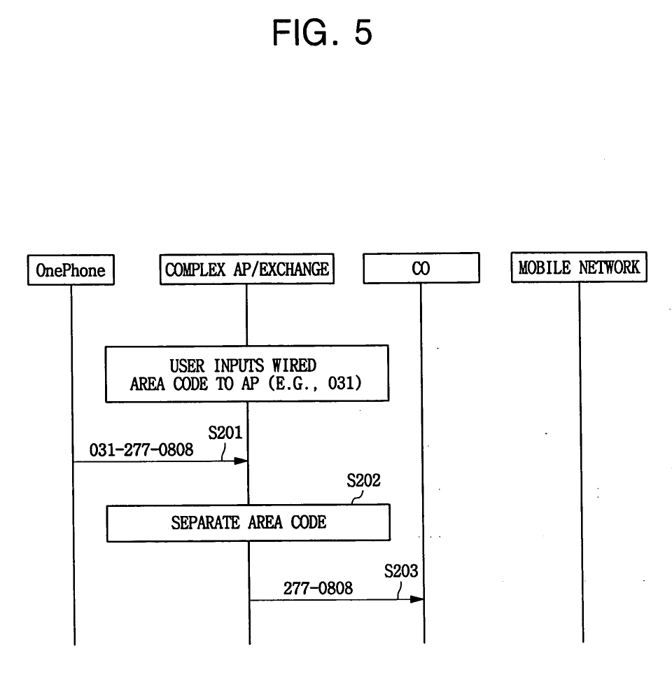

A process of hanlding dialed digits when a one-phone terminal user dials an office line number, which is identical to that of a home in which the AP is placed, in the above-stated process will be described with referece to FIG. 5.

FIG. 5 illustrates a process of handling a wired phone number in an AP when the wired phone number is transmitted to the AP via a complex wireless terminal device.

First, if a user transmits the wired phone number, i.e., a phone number including an area code (e.g., 031-****-****) to the AP or a private branch exchange via a one-phone terminal (S201), the AP or the private branch exchange analyzes the phone number transmitted from the one-phone terminal to determine whether it is a phone number including the area code.

If it is determined that the area code is included in the phone number (i.e., digits) transmitted from the one-phone terminal, it separates the associated area code (S202), and then transmits only the digits of a net correspondent phone number to a public branch exchange via a PSTN line (S203).

This can be a convenience for the users because most of the users are used to inputting the area code when dialing any wired phone number using their mobile terminal device.

That is, the AP is intended to handle associated digits after recognizing the digits received from the one-phone terminal and analyzing whether it is an extension call inside the AP or an office line call, and the one-phone terminal is basically intended to give the convenience to subscribers in the broadband public network, in which, assuming that the subscribers can use the same method as an existing one, the dialed number it is prevented from unintentionally using a system used in the broadband network.

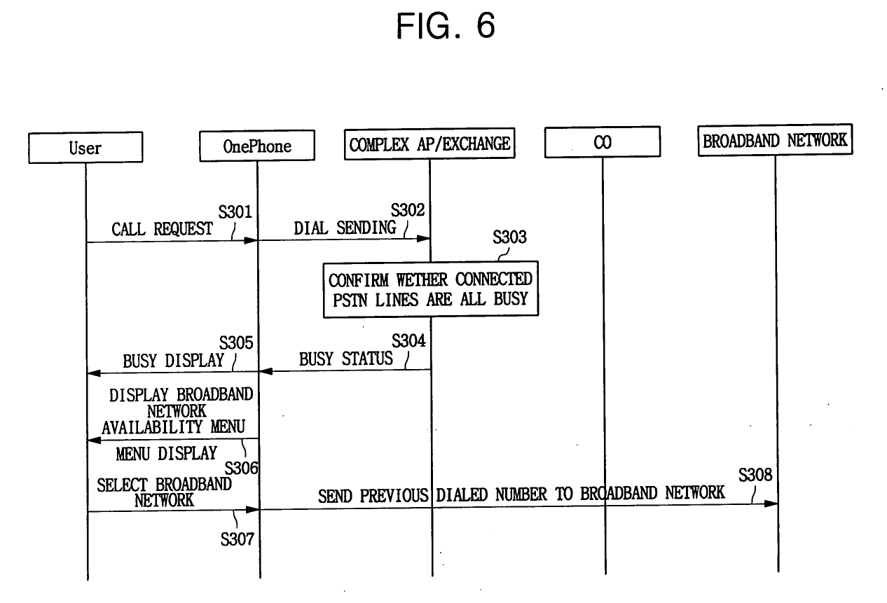

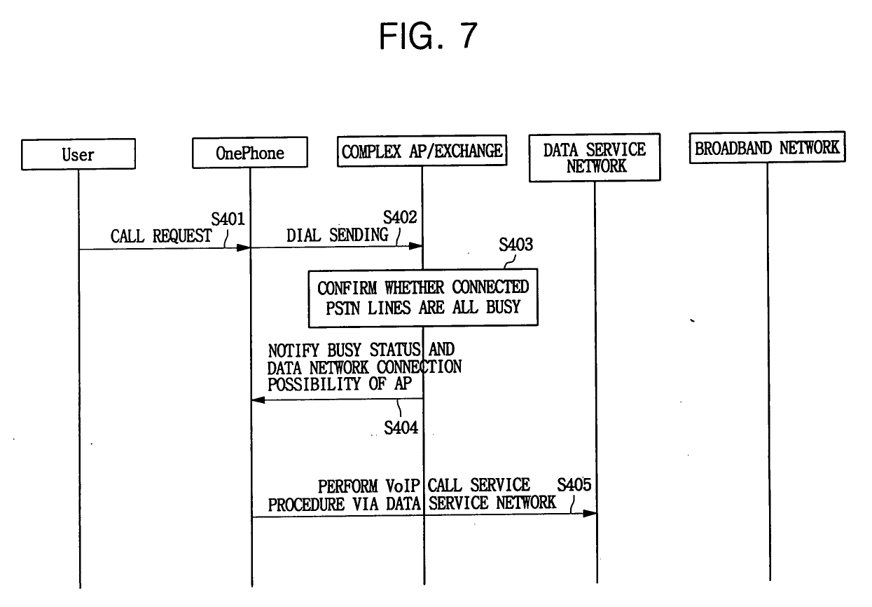

A call forwarding method to another network when PSTN lines connected to a narrowband service AP are all busy with respect to an originated call upon an outgoing call from the one-phone terminal device will be described with reference to FIGS. 6 and 7.

FIG. 6 illustrates a call forwarding procedure to a broadband wireless service network upon an outgoing call from a complex wireless terminal device to the AP, and FIG. 7 illustrates a call forwarding process to a VoIP network upon an outgoing call from the complex wireless terminal device to the AP.

The call forwarding procedure to the broadband network will be first described with reference to FIG. 6. If a user sends a phone number for a call to the AP via a one-phone terminal (S301 and S302), the AP determines that the PSTN lines, connected to the AP, are all busy (S303).

If it is determined that all of the PSTN lines connected to the AP are busy, the AP sends a current PSTN line status information to the one-phone terminal to display it on the one-phone terminal (S304 and S305).

At this time, the AP provides the PSTN line status information for the one-phone terminal, and at the same time, provides information to indicate that a call forwarding to the broadband network is available, such that a broadband network availability menu is displayed on the one-phone terminal (S306).

When the user selects a call forwarding menu to the broadband network in response to the displayed broadband network availability menu (S307), the AP will send the phone number (i.e., digits), which the user has previously sent, to the broadband network (S308).

As a result, when the PSTN lines connected to the narrowband service AP are all busy with respect to an outgoing call of the one-phone terminal, the AP notifies the PSTN line busy status to the narrowband terminal, such that it is displayed on the one-phone terminal and a selection menu to perform a broadband network service utilization is displayed on the one-phone terminal, and thus the user can select the call forwarding to the broadband network.

If a call is not available due to a preceding occupation of the PSTN lines upon an outgoing call of the one-phone terminal associated with a data service network, the call forwarding can be changed according to whether the data line is connected to the AP. When there is the data line at the AP, a VoIP call service can be performed via the data line and when there is no data line at the AP, the call service can be provided via the external network (i.e., CDMA, GSM, GPRS, WCDMA or the like).

A procedure of connecting a call of the one-phone terminal to the VoIP network when the data line is connected to the AP will be described with reference to FIG. 7.

As shown in FIG. 7, first, if the user sends a phone number for the call to the AP via the one-phone terminal (S401 and S402), the AP confirms whether the PSTN lines connected to the AP are all busy (S403).

If the PSTN lines are all busy, the AP provides current busy status information of the PSTN line and data network connection possibility information of the AP for the one-phone terminal (S404).

When the one-phone terminal requests connection to the data network in response to the current busy status information of the PSTN line and the data network connection possibility information sent from the AP, the AP will perform a VoIP call service procedure via the data service network (S405).

As a result, in the VoIP call service procedure via the data service network, the call service to the PSTN line via the media gateway shown in FIG. 1 is performed, or a call can be delivered to the MSC of the mobile network via the media gateway. It will be possible to make a call with another mobile data service terminal via the data network and the broadband network.

An operation of receiving an incoming call in the one-phone terminal will be described in detail with reference to the accompanying drawings.

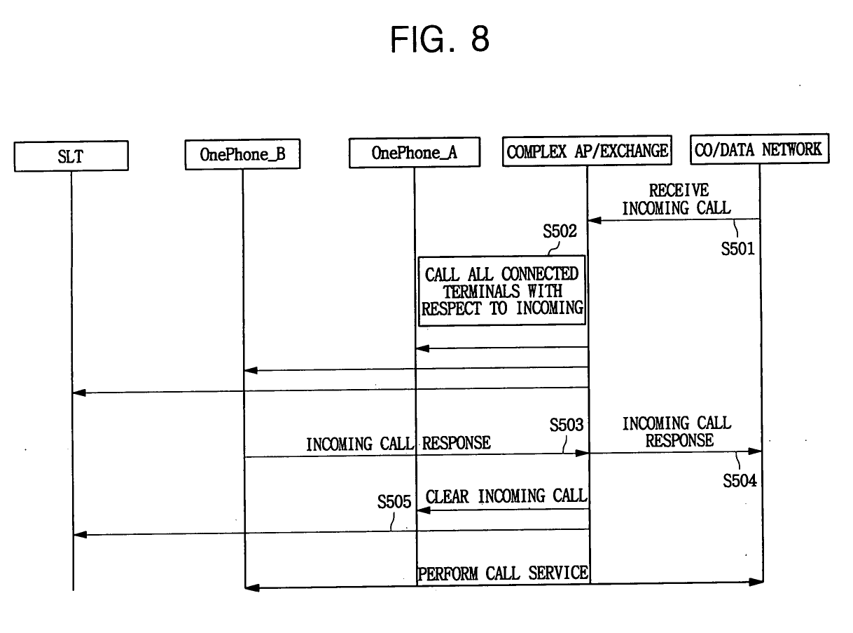

FIG. 8 illustrates a process of handling an incoming call when the incoming call is received from a PSTN network/data network to the AP.

As shown in FIG. 8, first, when receiving the incoming call transmitted from the PSTN line or data network (S501), the AP calls a wired telephone connected to the AP (i.e., an SLT (single line telephone) using PSTN lines or a VoIP phone using data lines) and dual mode wireless terminals supporting the narrowband, so that all of the terminals perform a simultaneous ringing operation with respect to the incoming call (S502).

When the wired phone connected to an internal network of the AP or one of the dual mode wireless terminal devices (i.e., one-phones) responds (S503), a response signal of the associated terminal is transmitted over the PSTN or the data network. The AP completes the ringing operation by eliminating calls of other terminals with the exception of the responding terminal, and performs a call service connection between the terminal that responds to the incoming and originating terminal (S505).

Furthermore, the AP or the exchange supporting a narrowband wireless network service provides an incoming specifying function for CID (Caller ID). When the incoming call is requested from the office line, it confirms tentatively named ‘CID to onephone DB’ to perform an initial incoming call only to the found one-phone terminal and then, when there is no response for a certain period of time, to allow another terminal to serve the incoming call.

A process of performing a call service to a specific terminal using the CID will be described.

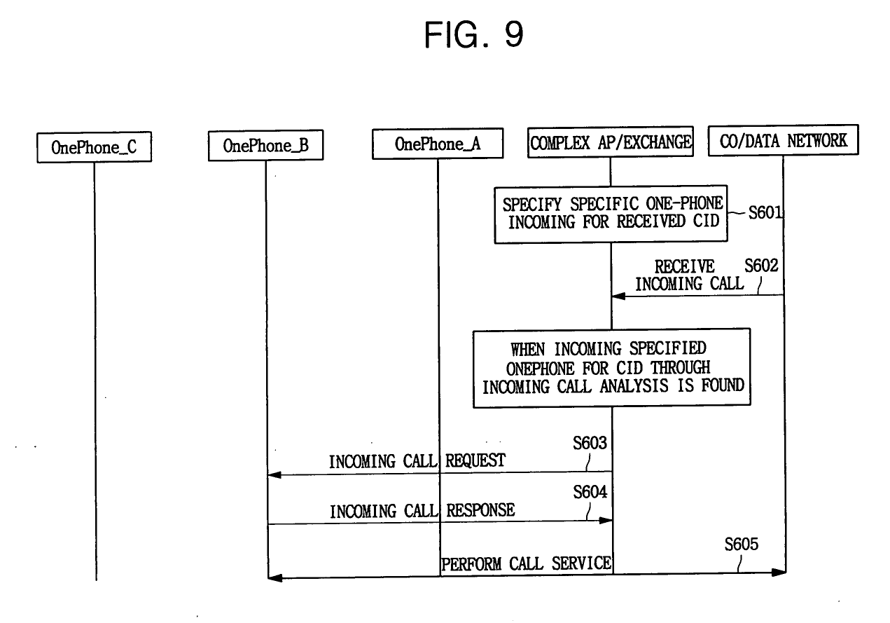

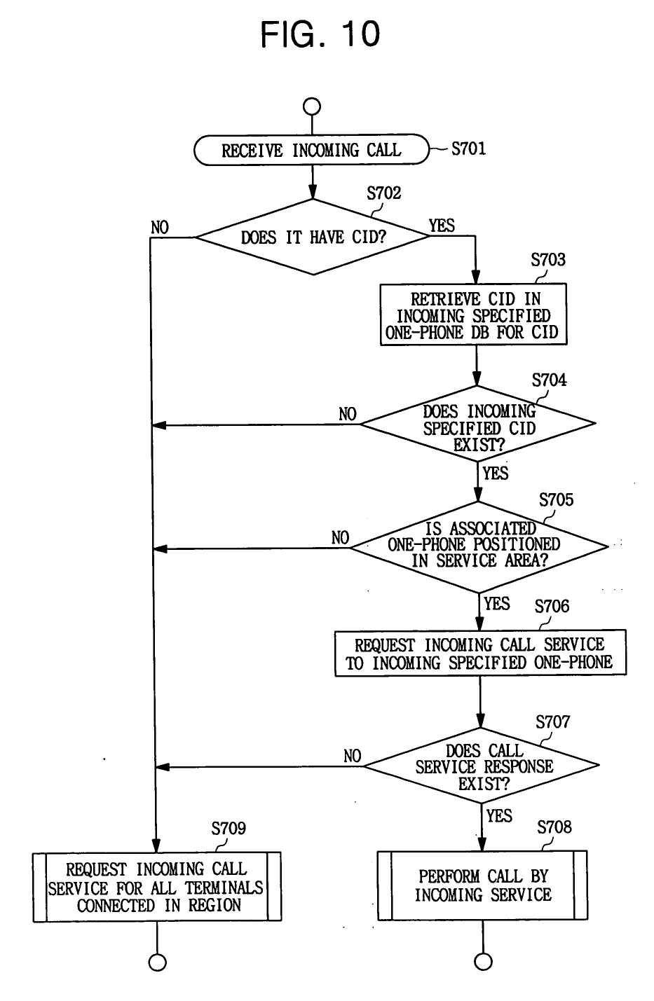

FIG. 9 illustrates a process for hanlding a call to a specific terminal when an incoming call is received from a PSTN network/data network to the AP, and FIG. 10 is an operation flowchart specifically illustrating a handling process shown in FIG. 9.

First, as shown in FIG. 9, a specific one-phone terminal incoming for a received CID is specified into a database in the AP or the private branch exchange (S601).

When the incoming call is received from the PSTN/data network after the specific one-phone terminal incoming for the CID has been specified (S602), the AP or the private branch exchange will analyze whether the CID is included in the received incoming, and when the CID is included, retrieves an incoming one-phone terminal specified in the database of the AP or the private branch exchange.

If the one-phone terminal corresponding to the CID for the received incoming call exists, the associated one-phone terminal is called (S603).

When a call response exists from the called one-phone terminal, the AP or the private branch exchange will provide a call service by connecting a call between the terminals (S604 and S605).

The above-stated process will be described in more detail and in steps through a flowchart shown in FIG. 10.

First, as shown in FIG. 10, when an incoming call is received from the PSTN/data network (S701), the AP or the private branch exchange analyzes whether the CID is included in the received incoming call (S702).

If it is determined that the CID is included in the received incoming call, the AP or the private branch exchange retrieves the incoming one-phone terminal specified in the database of the AP or the private branch exchange (S703) to determine whether or not the incoming specified terminal exists, namely, to determine whether the incoming specified CID exists (S704).

If it is determined that the incoming specified one-phone terminal exists, a determination is made as to whether the associated one-phone terminal is positioned in a one-phone service area (S705), and when the associated one-phone terminal is positioned in the one-phone service area, the AP or the private branch exchange requests the incoming call service to the incoming specified one-phone terminal (S706).

If a call service response exists from the associated incoming specified one-phone terminal upon the incoming call service request, the AP or the private branch exchange connects the call between the terminals to perform the call service (S708).

Meanwhile, if the incoming specified one-phone terminal does not exist in the database in the AP or the private branch exchange, and if the associated incoming specified one-phone terminal is not positioned in the one-phone service area, and if no call service response exists from the associated incoming specified one-phone terminal, then the AP or the private branch exchange requests an incoming call service to all terminals connected to the AP. That is, when all terminals connected to the AP are called and a service response from one of the terminals exists, a call with the associated terminal is achieved (S709).

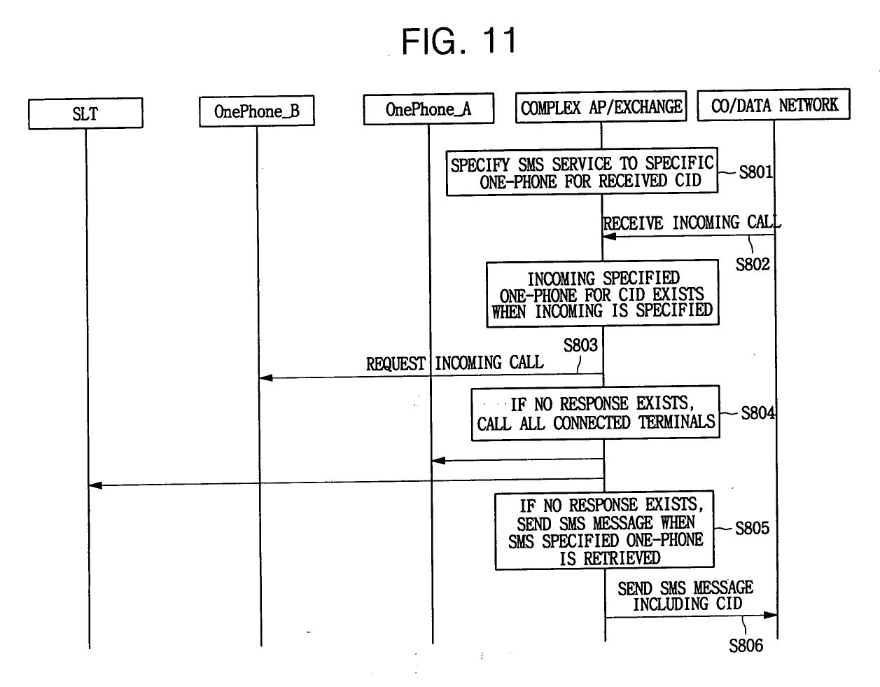

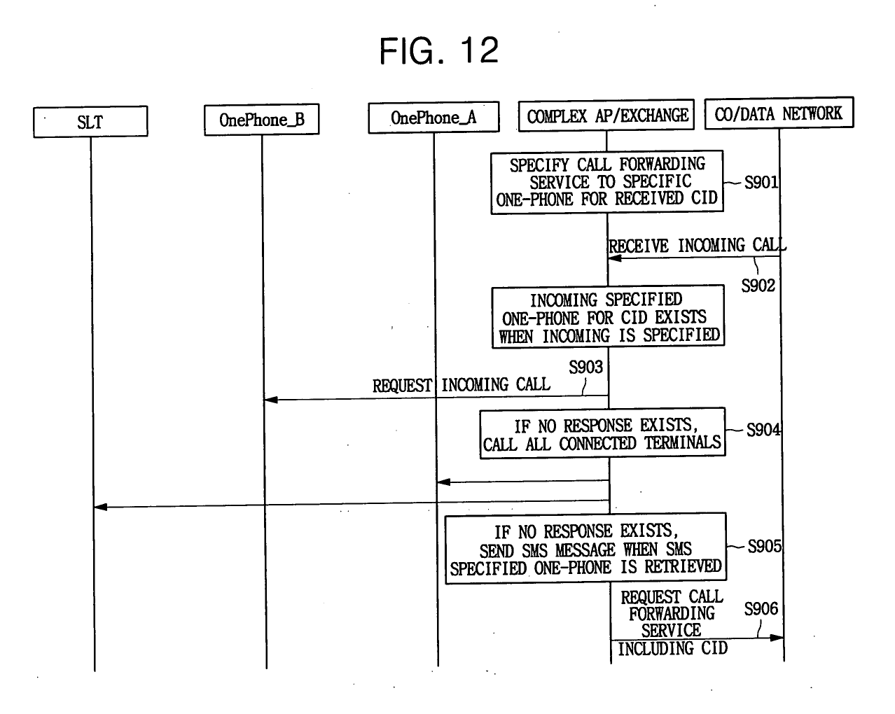

Furthermore, when no response exist from all of the terminals connected to the AP with respect to a call from a office line (i.e., a PSTN or data service network) via a wired network, the received CID is analyzed and information on the incoming call is delivered by an SMS message to a predefined incoming specified one-phone terminal, or a call forwarding service to the specified terminal is performed. This process will be described with reference to FIGS. 11 and 12.

FIG. 11 illustrates a process for delivering an SMS message to a one-phone terminal for an incoming call when the incoming call is received by the AP from a PSTN network/data network, and FIG. 12 illustrates a call forwarding service process for an incoming call when the incoming call is received by the AP from the PSTN network/data network

First, as shown in FIG. 11, an SMS service is specified to a specific one-phone terminal for the received CID into a database in the AP or the private branch exchange (S801). That is, when a call service is requested to the associated specific terminal while the call service is specified into the specific terminal for the received CID, the SMS service is specified to send the SMS message to the associated specific terminal upon no call service response from the terminal.

When the incoming call is received via the PSTN or data network while the SMS service is specified into the specific terminal (S802), the AP or the private branch exchange determines whether if the CID is included in the received incoming call.

If it is determined that the CID is included in the associated incoming call, the AP or the private branch exchange retrieves information from the database as to whether or not the incoming specified one-phone terminal for the associated CID exists.

If the incoming specified one-phone terminal exists, the AP or the private branch exchange requests the incoming call to the associated one-phone terminal (S803).

If no response is from the specified terminal in response to the incoming call request, a call to all other terminals connected to the AP is carried out (S804).

If no response to the call is from all of the terminals, an SMS message including the CID is transmitted to the SMS specified one-phone terminal (S805), and to the correspondent terminal via the PSTN or data network (S806).

A call forwarding service to the specified terminal can be performed after the SMS message has been transmitted. This process will be described with reference to FIG. 12.

As shown in FIG. 12, a call forwarding service to a specific one-phone for a received CID is specified into a database in the AP or the private branch exchange (S901).

After the call forwarding service is specified to the specific terminal, if an incoming call is received via the PSTN or data network (S902), the AP or the private branch exchange determines whether or not the CID is included in the received incoming call.

If it is determined that the CID is included in the associated incoming call, information is retrieved from the database as to whether or not the incoming specified one-phone terminal for the associated CID exists.

If the incoming specified one-phone terminal exists, the incoming call is requested to the associated one-phone terminal (S903).

When no response is received from the specified terminal in response to the incoming call request, all other terminals connected to the AP is called (S904).

When no respose is received from all of the other terminals after the call, the SMS message including the CID is transmitted to the SMS specified one-phone terminal (S905), and to the correspondent terminal via the PSTN or the data network (S906).

Furthermore, the AP or the private branch exchange requests a call forwarding service including the specified specific one-phone terminal information to a public branch exchange. Accordingly, the public branch exchange forwards the call to the specific terminal for the call forwarding service specified into the database in the AP or the private branch exchange, and performs the call incoming request to the forwarded terminal (S906).

Hereinafter, a method of handling a call received from an external network (GSM, CDMA, and so on) via the PSTN or the wired VoIP call through the one-phone terminal (both outgoing and incoming) will be now described.

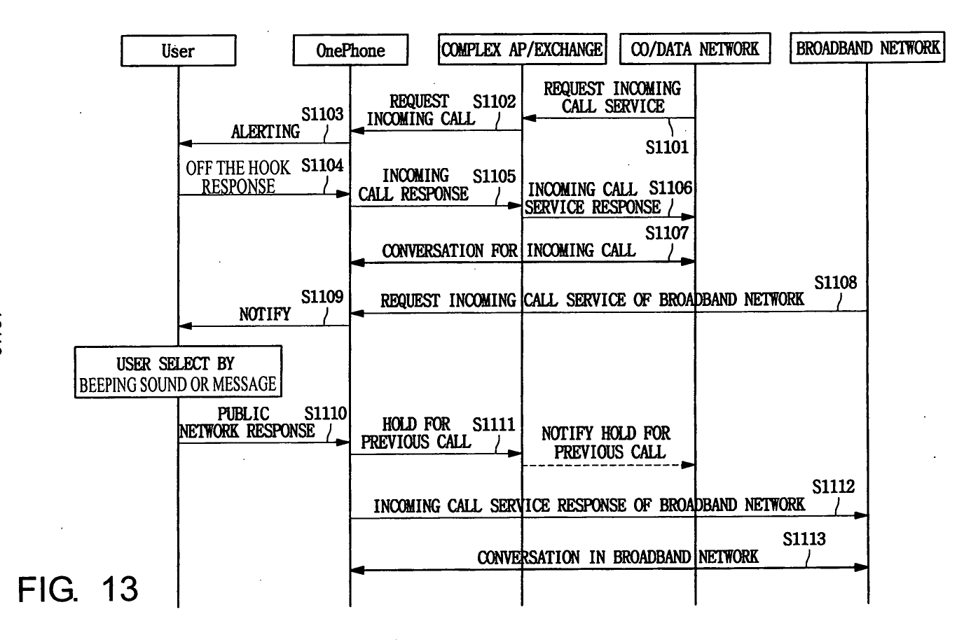

FIG. 13 illustrates a process of handling an incoming call when the incoming call is received from a broadband wireless service network while a complex wireless terminal device is busy.

First, as shown in FIG. 13, when the incoming call service request exists via the PSTN or the data network (S1101), the AP or the private branch exchange requests the incoming call to the one-phone terminal device, and the one-phone terminal notifies a user that the incoming call has been received (S1102 and S1103).

Thus, the user takes the one-phone terminal device off the hook, and the one-phone terminal sends a response signal to the incoming call to the AP in response to the user taking the one-phone terminal device off the hook (S1104 and S1105).

The AP sends an incoming call service response signal to the PSTN or the data network (i.e., public branch exchange) in response to the incoming call response signal transmitted from the one-phone terminal (S1106).

Accordingly, conversation for the incoming call with the one-phone terminal is made via the PSTN or the data network (S1107).

When the incoming call service is requested to the one-phone terminal via a broadband network while conversation between the terminals is thus made via the PSTN/data network (S108), the one-phone terminal displays to the user a broadband network incoming call service request in the form of a beeping sound or a message, notifying the user of incoming call information so that the user can decide whether or not to receive the incoming call from the broadband network is selected (S1109).

If the user selects an arbitrary key to receive the incoming call from the broadband network, that is, if the user responds the incoming call from the broadband network, the one-phone terminal requests the AP to hold a previous call, namely, a call that is currently in progress via the PSTN or the data network.

Thus, the AP holds the previous call in response to a hold signal for the previous call sent from the one-phone terminal, and notifies the hold for the previous call over the PSTN or the data network (S1111).

Furthermore, the one-phone terminal sends a response signal to the incoming call transmitted from the broadband network (S1112), and performs a conversation with the correspondent terminal via the broadband network (S1113).

As a result, upon an incoming call generation from the external network, the terminal itself notifies the incoming call generation to the user by means of a beeping sound or a message.

When the user who has received the incoming call generation message presses a call button, he can respond to the call from the external network while holding the existing call. At this time, the terminal user's dropping or holding the existing call (i.e., the call via the wired line) can be selected by the user. That is, it can be a selection matter or a fixed matter in using the terminal.

Alternatively, a specific key (button) can be provided to eliminate the existing call and to service a call from the external wireless network, and another specific key (button) can be provided to ignore a service for a new call.

Hereinafter, a call service operation will be described when a one-phone terminal moves between service areas, for example, from a narrowband service area to a broadband service area.

A determination as to whether or not the terminal departs from narrow band coverage is based on an appropriate threshold value specified per service coverage when an RSSI (Radio Signal Strength Indication) level of a pilot or sync channel of the narrowband service becomes low or a data error rate becomes high.

For example, an area where the one-phone terminal can be positioned can be divided into an area having high RSSI values so that a scan is not required, an area where the RSSI level of the terminal is scanned, and an area where a one-phone terminal begins to depart from the narrow band. That is, if the RSSI has a value more than a first reference value, it is determined that the one-phone exists in the associated area because the intensity of the pilot signal is high, if the RSSI value is less than a second reference value, which means that the pilot signal can not be sensed and an error rate value is very large, it is determined that an associated one-phone terminal departs from the associated area. Furthermore, if the RSSI has a value between the first reference value and the second reference value, it is determined that the one-phone terminal has departed from the associated area and the scanning operation of the one-phone terminal is continuously performed to confirm whether to depart from the coverage.

When a current call of the one-phone terminal is a voice call, upon movement of the one-phone terminal from the coverage, the user is notified of the coverage departure situation by a voice signal (e.g., voice message, beep, melody, and so on), and when a current call of the one-phone terminal is a data call (a case of receiving a data service), the user is notified by displaying a message, a pictogram or the like indicating the coverage departure situation on a liquid crystal screen of the one-phone terminal. Needless to say, an integrated notification method can be used for each of the voice call and the data call.

A mode switching operation upon coverage movement of the one-phone terminal is described below.

If the one-phone terminal moves from an external network to the AP in the narrowband service area, the AP can perform an automatic mode switch of the terminal depending on retrieving through a periodic signal transmission to the one-phone terminal, or a user can request usage mode switch (narrowband service or broadband service) by notifying the movement to the one-phone terminal.

If the terminal cannot receive any signal from the AP after moving from the AP to the external network (i.e., a broadband network), the terminal network-operates in an external network connection mode. At this time, the terminal performs a periodic retrieving operation whether or not any signal from the AP exists.

A determination as to whether or not the one-phone terminal moves into the external network depends on a decreasing signal intensity from the AP in the narrowband network or an increasing signal or a data error rate along with the decreasing intensity as described above, which can be obtained in the one-phone terminal and in the AP by a method that is provided in respective narrowband protocols. It can be determined that the one-phone terminal has departed from the narrowband service area when the RSSI and the error rate deviate from threshold values thereof for a service area predescibed in the one-phone terminal. Data received from the AP at these threshold values are regarded as normally unusable data and are discarded.

A scanning period of the one-phone terminal should be determined so that a movement between service networks is automatically realized, and also meet a scheme capable of minimizing the power consumption in the terminal.

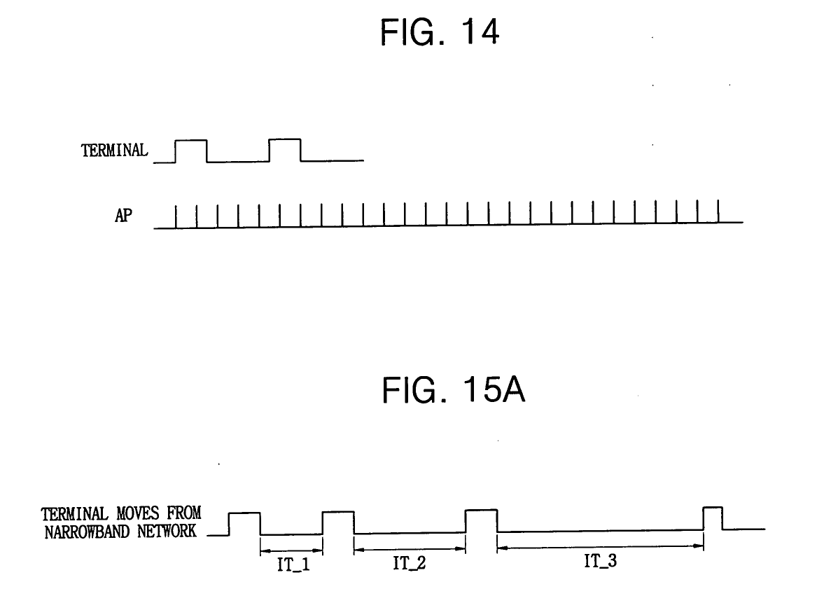

Hereinafter, a scanning method of a one-phone terminal upon coverage movement of the terminal will be described with reference to accompanying FIGS. 14 to 16.

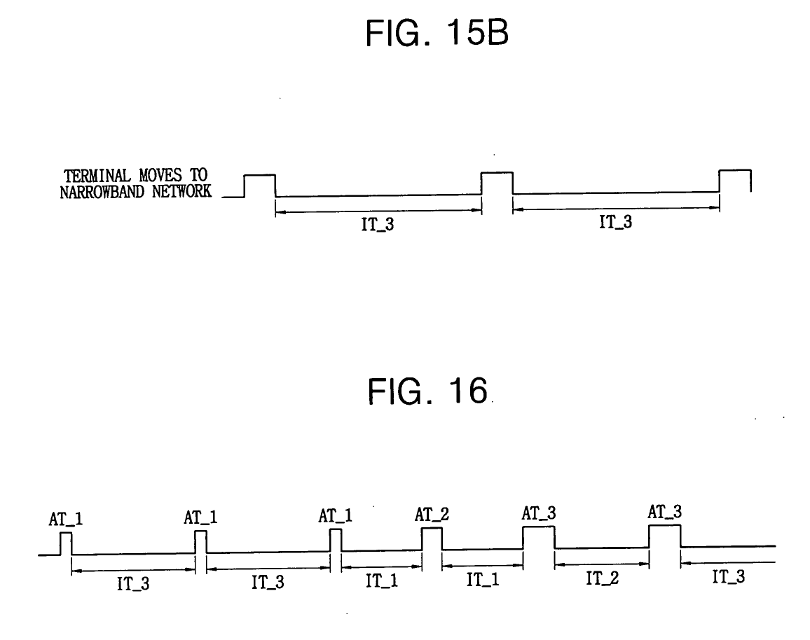

FIG. 14 illustrates a time period for explaining an active scanning operation of an complex wireless terminal device to the AP, FIGS. 15a and 15b illustrate scanning periods of a complex wireless terminal device when the terminal device moves from a narrowband wireless service network and when the terminal device moves to the narrowband wireless service network, respectively, and FIG. 16 illustrates a scanning period of the terminal device at a boundary between the narrowband and broadband wireless service areas.

FIGS. 14 to 16 show the scheme with a horizontal axis as a time axis with respect to a movement of the one-phone terminal.

As shown in FIG. 14, an active scanning duration of the one-phone terminal is at least larger than a paging interval time of the AP.

There can exist a case where the AP does not perform paging and responds only when a request from the terminal exists according to a narrowband service protocol, which does not affect the active scanning duration of the terminal, and requires waitng a maximum response time of the AP.

Furthermore, if it is determined that the one-phone terminal is moving from the narrowband network to broadband network, a determination as to whether or not the terminal moves is carried out depending on the RSSI and the signal/data frame error rate as shown in FIG. 15a, and when it is determined that the terminal has moved, the scanning period is made short and when the terminal departs from a service area, the scanning period is widened to reduce power consumption of the terminal. That is, idle time periods (IT1, IT2, IT3 and so on) become large.

On the contrary, if the one-phone terminal moves from the broadband network to the narrowband network, a scan is performed in the period that has been performed in the broadband because movement to the narrowband network is not known and, when at least one AP scanning is completed, the scanning period is changed as shown in FIG. 15b, so that the movemnet to the narrowband is rapidly determined.

Furthermore, a relationship between the scanning period and scanning duration is as shown in FIG. 16 when the terminal moves to the broadband while it stably operates in the narrowband, in which the scanning period is made short for rapid determination at the boundary between the narrowband and the broadband.

In a situation where handoff to the internal network of the AP is required when the terminal has moved from the broadband network (external network) to the narrowband (AP), it is possible to notify usage of the internal network to a one-phone management server of the external network (AAA 900 of FIG. 1) via the AP wired data network, or to notify the usage of the internal network to the one-phone management server of the external network via the external network before the internal network is used.

Upon moving from the AP to the external network, the AP recognizes that the one-phone is not sensed and notifies the one-phone management server of the movement of the one-phone to the external network. Alternatively, the one-phone that has moved to the external network can directly notify the external network one-phone management server of the terminal movement via the external network.

Hereinafter, a method of performing a data service in a narrowband service network using one-phone terminal will be described with reference to the accompanying drawings.

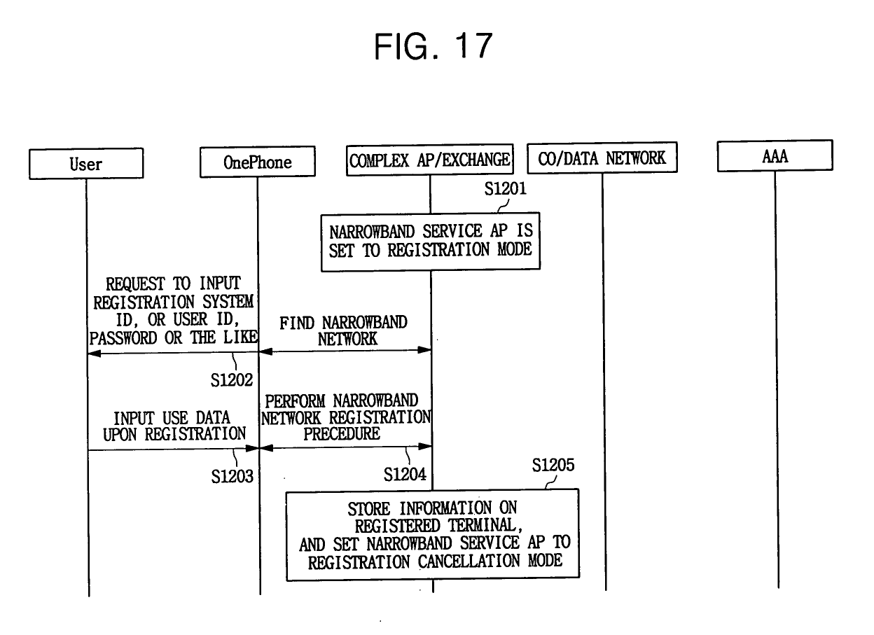

First, a method of initially registering the one-phone terminal to the narrowband service network will be described with reference to FIG. 17.

FIG. 17 illustrates a narrowband service network registration precedure for receiving data service in a complex wireless terminal device.

As shown in FIG. 17, a narrowband service AP is first set to a registration mode (S1201).

Subsequently, the one-phone terminal requests a user to input a registration system ID, or information such as a user ID, a password or the like (S1202).

If various information for registration of the one-phone terminal is inputted from the user, the one-phone terminal sends the inputted information to the AP (S1203), and the AP performs the narrowband network registration precedure based on the various information sent from the one-phone terminal (S1204).

The AP stores information on the registered one-phone terminal, and sets the narrowband service AP to a registration cancellation mode (S1205).

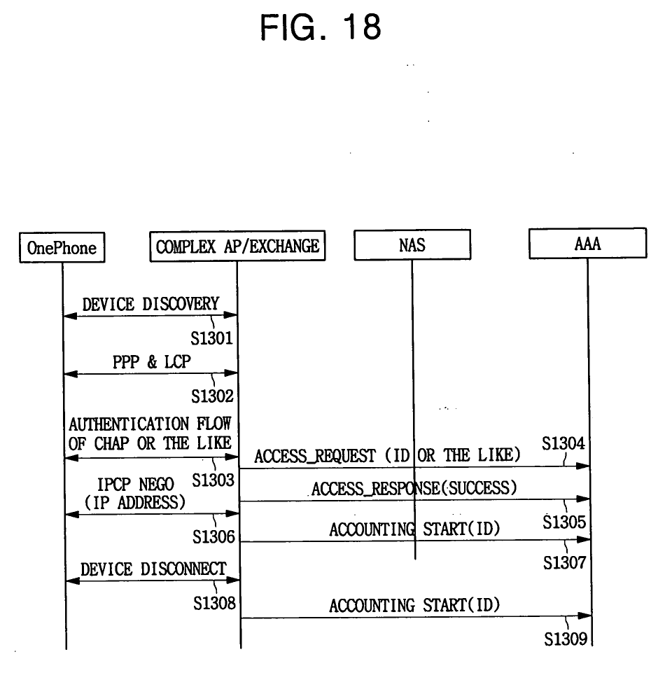

Meanwhile, a method in which the one-phone terminal is registered in the narrowband network through the above-stated process and thereafter uses a wired data network will be described with reference to FIG. 18.

FIG. 18 illustrates a process of using a public wired data network that supports a narrowband wireless service using a complex wireless terminal device.

As shown in FIG. 18, it is a method of providing a service in case where the AP or the private branch exchange, which supports a one-phone terminal service, has lines available for a data service other than a PSTN interface.

First, all one-phone terminals can have a temporary IP or a stationary IP via an IP allocation procedure to use the data service, if possible.

In a process of acquiring these IPs, it is possible to perform authentication of the one-phone terminal device, in which a manner mainly used in the authentication performs the authentication of the terminal or user by inter-changing the user ID, password or the like using PPP (point-to-point) protocol (authentication flow of PAP, CHAP or the like) to open a data session between the one-phone and the wired data service network and to perform Account_start for the data session.

In addition, a separate authentication protocol can be used after IP allocation via DHCP (Dynamic Host Configuration Protocol). In such a case, both encryption and authentication are carried out in a Layer 3 level. Presently, the encryption used herein includes 802.1× or the like.

In the case of the one-phone user, in order to first perform the data service, an independent hot key is placed in the one-phone, or it can be connected to the wired data service network using a menu key and an item key on a sub menu.

The one-phone is connected to a wired content server (application server 1100 shown in FIG. 1) via the connected wired network, in which the one-phone can provide a game, a bell sound, and the like of the one-phone via the content server, and the public network can connect to the content server of the wired network to provide the one-phone user with a one-phone user's speccialized home networking service (e.g., home view, home electronics control service and the like).

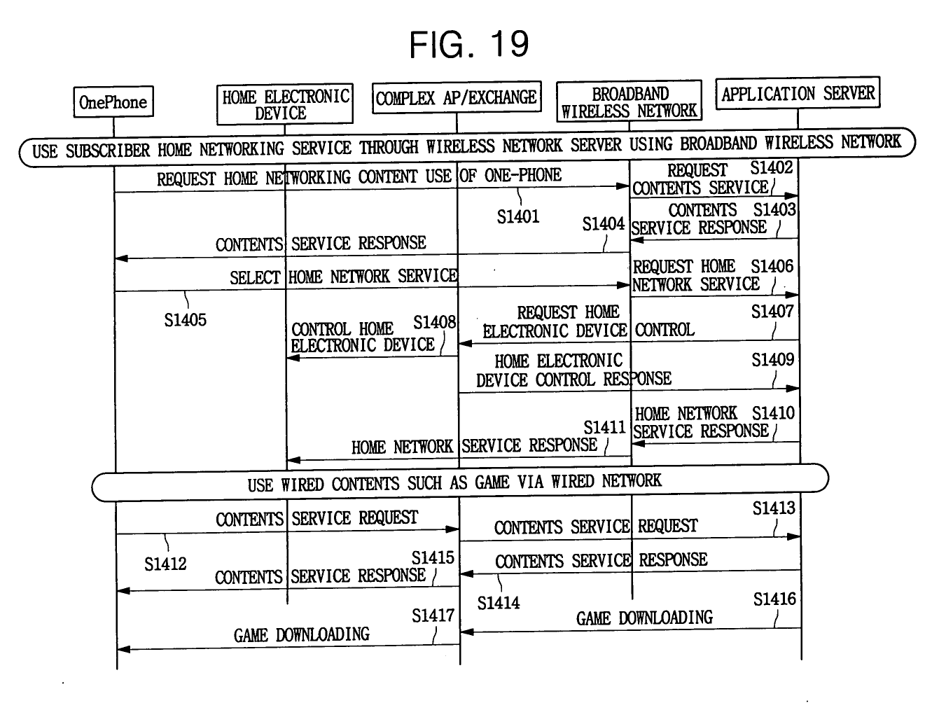

This method will be described in detail below with reference to FIG. 19.

FIG. 19 illustrates a process of receiving a content service via a wired data network/broadband network in a complex wireless terminal device.

As shown in FIG. 19, first, in case of using a home networking service using an 8 application server positioned in a wired network via a broadband wireless network, a one-phone terminal sends a signal for requesting home networking content use of the one-phone to the broadband wireless network (S1401).

The broadband wireless network requests the content service to the application server of the wired network according to a request of the one-phone (S1402).

The application server sends a response signal to the content service request via the broadband wireless, to the one-phone terminal via the broadband wireless network (S1403 and S1404).

The one-phone selects the home network service according to the content service response, to send it to the application server via a broadband wireless network (S1405 and S1406). The home network service is a service for a home electronic device control in a home, and the home network service selection is a selection of a home electronic device to be controlled and a function to control the associated home electronic device.

The application server requests the home electronic device control to the AP according to a home electronic device control service request sent from the one-phone terminal (S1407).

Accordingly, the AP will control the associated function of the associated home electronic device according to the home electronic device control request from the application server (S1408).

If the control is completed, the AP will send a home electronic device control response signal to the application server (S1409), and the application server, which has received the home respose signal, will send the home electronic device control, i.e., a response signal to the home network service completion, to the one-phone terminal via the broadband network (S1410 and S1411).

A method for performing wired content service such as a game or the like in a one-phone terminal via a wired network will be described below.

As shown in FIG. 19, the one-phone terminal requests a content service to the AP (S1412).

The AP also requests the content service to an application server via the wired network in response to the content service request from the one-phone terminal (S1413).

The application server provides the one-phone terminal with a response signal to the content service request via the AP in response to the content service request from the AP content (S1414 and S1415), and downloads various contents such as a game, a bell sound or the like, namely, content information requested by a user stored in the application server via the AP (S1416 and S1417).

The complex wireless service device and method thereof using a wired or wireless communication system according to the present invention provide the following effects for all of the users and wired and wireless companies:

There are the following effects to the end user:

First, since it is required to manage only one account in place of both accounts for wired and wireless telephone uses, a use charge is less (in particular, in case of a wireless telephone charge, the charge is much less since it is possible to use the wired telephone).

Second, in case of using an AP extension, a separate cordless telephone is not required, thereby saving the cost.

Third, it is possible to change limitation to a mobile phone at any time, used by children, through a web-based management.

Fourth, it is possible to receive a high-quality of voice service by using an internal network of the AP, and not by using an external wireless network.

Fifth, there is a convenience that a dual mode handset (i.e., one-phone) can be used as one terminal anywhere (services can be received with the same terminal anywhere such as in a home, in an office or in outdoors).

Sixth, in the internal network of the AP, an incoming is carried out using an internal telephone (i.e., SLT, VoIP phone, cordless phone, or the like) other than the one-phone.

In the wired and wireless company's position, the following effects are obtained.

First, in the wireless network company's position, if the one-phone user uses a wired network via an internal network of the AP, investment cost can be reduced for a good quality of wireless network services, and more many wireless network users can use a network having the same capacity.

Second, it is possible to secure users who do not determine whether to use the wireless network service due to convenience and saved usage charge.

Third, in the wireless network company's position, a load to a shaded region is mitigated and a cell coverage where a high-quality of service is available is widened.

Fourth, in the wired network company's position, wired network users are secured, thereby increasing the usage charges.

Fifth, it is possible to have a competitive power as compared to other companies that do not provide such services.

What is claimed is:

1. A complex wireless service arrangement comprising:
an Access Point (AP) using a narrowband wireless protocol and connected to a Digital Subscriber Line Access Multiplexer (DSLAM) in an inhouse area and to a Private Branch Exchange (PBX) in an inbuilding area via one of an internal wired or wireless complex gateway depending on a wired network structure connected to either a public network or a private network, the AP adapted to selectively send information to the complex wireless service arrangement and to at least one terminal connected to the private network, or to send incoming paging information to the terminal, and to receive a connection signal from the wireless complex service arrangement to allocate a network connection channel, and to selectively provide a gateway function via a Public Switched Telephone Network (PSTN) connection, a Local Area Network (LAN) connection via a wired communication line connection, and a handoff between APs in the private network;
a gateway connected to the private and public networks and adapted to interface data therebetween;
a Home Location Register (HLR) arranged in the gateway and at least one of the private network or public network and adapted to store at least one of public or private network subscriber information, and to perform perfect failure monitoring and real time database processing, and to perform both registration and cancellation of the private or public network subscriber information and complex wireless service arrangement information, and to perform renewal of information in association with at least one of a switching center, a short message service center, a network management center and a customer center;
an Authentication, Authorization and Accounting (AAA) server arranged in the private and public networks and adapted to manage authentication, authorization and accounting of private and public network subscribers; and
a wired management server arranged in the broadband and wired networks and adapted to provide content information requested by a user when content services are requested from the complex wireless service arrangement via one of the broadband network or the wired network.

2. A method of handling an outgoing call in a wireless terminal using a complex wireless service arrangement, the method comprising:
performing a call service setting procedure at an Access Point (AP) using a narrowband wireless protocol and performing call resource confirmation and terminal authentication in response to a call setup request from the wireless terminal to the AP;
providing a call setup response signal to the wireless terminal, and connecting the call to Public Switched Telephone Network (PSTN) line upon completion of the terminal authentication; and
generating a ring-back tone signal at the wireless terminal to indicate that the call is being connected in response to the call setup response signal sent from the AP, and performing a call connection to a correspondent terminal in response to a busy signal generated after completion of the call connection.

3. The method of claim 2, further comprising:
sending call disconnection information of the wireless terminal from the PSTN to an Authentication, Authorization and Accounting (AAA) server if the correspondent terminal requests a call disconnection during a call between the wireless terminal and the correspondent terminal;
performing, at the AP, a call disconnection procedure using a narrowband wireless protocol in response to a call clearing request signal from the wireless terminal; and sending a call clearing response signal from the AP to the wireless terminal and sending terminal disconnection information to the AAA server after performing the call disconnection procedure.

4. The method of claim 2, further comprising:
sending a call disconnection request signal from the wireless terminal that requested the call to the AP in response to a call disconnection request from the wireless terminal during a call between the wireless terminal and the correspondent terminal;
performing, at the AP receiving the call disconnection request signal, a call disconnection procedure of the wireless terminal via the narrowband wireless protocol and eliminating the call connected to the PSTN line; and sending a call clearing response signal from the AP to the wireless terminal that has requested the call disconnection, and sending call disconnection information of the wireless terminal to the AAA server in response to the completion of the call clearing.

5. The method of claim 1, further comprising:
sending phone number information including area code information of a call to the correspondent wired terminal from the wireless terminal to the AP via the private network; and
separating the area code from the phone number transmitted from the terminal in the AP and thereafter transmitting only the net phone number information of the wired terminal to the PSTN line.

6. A method of call forwarding for an outgoing call of a wireless terminal using a wired and wireless complex service arrangement, the method comprising:
determining, at an Access Point (AP), whether Public Switched Telephone Network (PSTN) lines connected to the AP are all busy in response to a call signal received from the wireless terminal arranged in a private network;
providing current PSTN line status information and information indicating that a call forwarding to a broadband network is available to the wireless terminal, and transmitting broadband network availability menu information to the wireless terminal to display it on the wireless terminal in response to a determination that all of the PSTN lines connected to the AP are busy; and connecting a call from the AP to a correspondent terminal via the broadband network by sending a phone number previously transmitted by the wireless terminal to the broadband network via the gateway in response to the wireless terminal selecting a call forwarding menu to the broadband network in response to the displayed broadband network availability menu.

7. A method of handling an outgoing call of a wireless terminal using a wired and wireless complex service arrangement, the method comprising:
determining, at an Access Point (AP), whether Public Switched Telephone Network (PSTN) lines connected to the AP are all busy in response to a call signal received from the wireless terminal positioned in a private network;
sending current busy status information of the PSTN line and VoIP data network connection possibility information of the AP from the AP to the wireless terminal in response to a determination that the PSTN lines are all busy; and
transmitting a phone number previously sent by the wireless terminal from the AP to the data service network via a gateway to connect a call to a correspondent terminal via a VoIP network in response to a data network connection request from the wireless terminal in response to the sent current busy status information of the PSTN line and data network connection possibility information.

8. A method of handling an incoming call of a wireless terminal using a wired and wireless complex service arrangement, the method comprising:
specifying a Caller ID (CID) of a specific wireless terminal for an incoming call reception in a database in either an Access Point (AP) or a Private Branch Exchange (PBX);
analyzing whether or not the CID is included in the received incoming call at the AP or PBX in response to an incoming call received from a Public Switched Telephone Network (PSTN) or a data network;
retrieving the CID of the incoming wireless terminal specified in the database of the AP or PBX to determine whether or not the CID of the incoming specified wireless terminal exists in response to the CID being included in the received incoming call;
determining whether or not an associated specified terminal is positioned in the terminal service area in response to a determination that the incoming specified wireless terminal exists, and in response to a determination that the associated specified terminal is positioned in the terminal service area, requesting the incoming call service to the incoming specified wireless terminal; and
connecting a call between the associated terminal and the incoming specified wireless terminal and performing the call service in response to a determination that a call service response received from the associated specified terminal upon an incoming call service request.

9. The method of claim 8, further comprising requesting an incoming call service for all terminals connected to the AP in response to a determination that no the incoming specified wireless terminal exists in the database in the AP or PBX, upon an associated specified terminal not being positioned within the terminal service area, and upon no call service response from the associated specified terminal.

10. A method of handling an incoming call of a wireless terminal using a wired and wireless complex service arrangement, the method comprising:
specifying a Short Message Service (SMS) service for sending an SMS message to an associated specific terminal upon no call service response from the associated specific terminal in response to a call service request to the associated specific terminal while the call service is specified in a specific terminal for a received CID in a database in an Access Point (AP) or a Private Branch Exchange (PBX);
determining, at the AP or PBX, whether or not the CID is included in the received incoming call in response to an incoming call received via a PSTN or a data network while the SMS service is specified to the specific terminal;
determining whether or not an incoming specified terminal for the associated CID exists in response to a determination that the CID is included in the associated incoming call, and upon a determination that the incoming specified terminal exists, requesting the incoming call to the associated terminal;
calling all terminals connected to the AP in response to a determination that no response from the specified terminal exists in response to the incoming call request; and
sending an SMS message including the CID to the SMS specified terminal, and sending the SMS message including the CID to the correspondent terminal via the PSTN or the data network in response to a determination that no response to the call exists from all of the terminals after calling.

11. A method of handling an incoming call of a complex wireless terminal using a wired and wireless complex service arrangement, the method comprising:
specifying a call forwarding service to a specific terminal for a received Caller ID (CID) in a database in an Access Point (AP) or a Private Branch Exchange (PBX);
determining, at the AP or PBX, whether the CID is included in the received incoming call in response to an incoming call received via a PSTN or a data network while the call forwarding service is specified to the specific terminal;
determining whether or not an incoming specified terminal for the associated CID exists, and requesting the incoming call to the associated wireless terminal if the incoming specified wireless terminal exists upon a determination that the CID is included in the associated incoming call;
calling all terminals connected to the AP, and if no response to the call from the all terminals exists upon receiving no response from a terminal specified in response to the incoming call request, sending an SMS message including the CID to an SMS specified terminal, and then is sending the SMS message including the CID to a correspondent terminal via the PSTN or the data network; and
requesting, at the AP or PBX, a call forwarding service including specified specific terminal information to the PBX.

12. A method of handling an incoming call of a wireless terminal using a wired and wireless complex service arrangement, the method comprising:
requesting an incoming call, at an Access Point (AP) or a Private Branch Exchange (PBX), to the wireless terminal in response to an incoming call service request from a PSTN or a wired data network;
performing a call connection of the incoming call to the wireless terminal via the PSTN or the data network by sending an incoming call service response signal to the PSTN or the PBX in response to the incoming call request from the wireless terminal;
notifying, at the wireless terminal, incoming call information as to whether or not the incoming call from the broadband network has been received by a sounding a beep or displaying a message for a broadband network incoming call service request in response to an incoming call service request to the wireless terminal via the broadband network while a call between terminals is made via the PSTN or data network; and
holding the previous call at the AP and notifying the hold for the previous call to the PSTN or the data network, and then sending a response signal to the broadband network to connect the call with a correspondent terminal via the broadband network in response to a hold request for an previous call using an arbitrary key of the wireless terminal to receive the incoming call from the broadband network.

13. A content service method via a wired network in a wired and wireless complex service arrangement, the method comprising:
requesting, at an Access Point (AP), a content service to an application server via the wired network in response to a content service request of a wireless terminal; and
sending, at the application server, a response signal to the content service request to the wireless terminal via the AP in response to the content service request from the AP, and then downloading content information, requested by a user, and stored in the application server, to the wireless terminal via the AP.

14. A home networking service method using a wireless terminal in a wired and wireless complex service arrangement, the method comprising:
requesting a content service to an application server of a wired network via a broadband wireless network in response to a home networking service request from the wireless terminal via the broadband wireless network to use the home networking service using the application server of the wired network via the broadband wireless network;
sending a response signal from the application server to the wireless terminal via the broadband wireless network;
selecting a desired home network service to send to the application server via the broadband wireless network according to a home networking service response of the application server;
requesting, at the application server, a home electronic device control to an Access Point (AP) in response to the home electronic device control service request sent from the wireless terminal;
controlling, at the AP, an associated function of an associated home electronic device in response to a request of the home electronic device control from the application server, and
sending a home electronic device control response signal to the application server, and sending a home networking service completion response signal from the application server that has received the home electronic device response signal to the wireless terminal via the broadband network.
